(19) United States
(12) Patent Application Publication
(10) Pub. No.: US 2003/0018659 A1
(43) Pub. Date: Jan. 23, 2003

(54) Category-based selections in an information access environment

(75) Inventors: Avi Fuks, Tel Aviv (IL); Ido Dagan, Ramat Hasharon (IL); Ido Yellin, Kfar Saba (IL); Ofra Pavlovitz, Ramat Gan (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LingoMotors, Inc., Cambridge, MA

(21) Appl. No.: 10/099,904

(22) Filed: Mar. 13, 2002

Related U.S. Application Data
(60) Provisional application No. 60/275,839, filed on Mar. 14, 2001.

(51) Int. Cl. G06F 17/30; G06F 7/00; G06F 17/24; G06F 17/21; G06F 17/00; G06F 15/00

(52) U.S. Cl. 707/500; 707/4

(57) ABSTRACT

A method for scoring indexing concepts for their relevancy in the context, including obtaining a collection of documents, classifying the collection of documents to a set of indexing concepts and scoring each indexing concept according to the relevancy of the indexing concept to the collection of documents.

### CROSS REFERENCE TO RELATED APPLICATION

This application is a nonprovisional application of and claims priority to U.S. Prov. application Ser. No. 60/275,839, entitled “CATEGORY-BASED SELECTIONS IN AN INFORMATION ACCESS ENVIRONMENT,” filed Mar. 14, 2001 by Avi Fuks et al., the entire disclosure of which is incorporated herein by reference for all purposes.

### FIELD AND BACKGROUND OF THE INVENTION

It is currently common practice within organizations as well as on the Internet, to provide a search engine that indexes a large repository of documents and enables users to issue a search query and subsequently receive in response all documents that satisfy the search conditions.

Usually, a list of titles, along with some additional information, is presented for each document, and the user can further ask for the display of specific documents from the list. The list of documents is often sorted by some relevance ranking, which is intended to approximate the degree of relevance of the document to the query.

In many systems, it is possible for the user to manually assign topical categories to a document. More recently, there have been developed a number of methods for assigning topical categories to documents automatically. Such methods classify documents to appropriate categories taken from a predetermined set of possible categories (this set may be represented using different data structures, including a list, a hierarchy tree, etc.). Classification is performed by some mechanism that receives the document text as input and determines the appropriate categories based on the words, terms or their combinations that appear in the document. The mechanism scores every document in relation to every category, and a document is classified into a category if its score is above some predetermined threshold.

There are two common approaches for automatic text classification methods. The first approach is based on manual definition of the rules, or some other type of logic by which a document is being classified into a category based on the terms in the text. Typically, the characterization of a category is referred to as the “profile” of the category. Basically, the profile is a weighted vector of terms, but it can include more sophisticated conditions. Every document is scored according to the correlation between the profile and the terms that appear in it. The second approach is based on automatic learning of the “logic” which entails the classification of the document into a category. Methods belonging to this approach utilize a set of training documents, for which the correct categories are known in advance (usually as the result of manual classification of these documents).

Once documents have been obtained by a user, as a result of some search or some routing mechanism, these documents are typically displayed in one of several formats and ranked according to their relevance.

In certain systems, the resulting documents are displayed in hierarchical form, e.g. a category tree. In accordance with hitherto known techniques, all categories to which the retrieved documents belong are displayed. This way, the resulting category tree may include irrelevant categories (a category may be irrelevant because of its subject or the documents it contains). This may not only annoy the user, but may also lead to the discarding of important information. Consider, for example, a scenario where the display window can accommodate only a few out of the entire hierarchy of categories, since a major portion of the window is already occupied by other data such as the query and the resulting document links. Since according to the prior art, there is no dynamic selection of categories but only a predetermined set of rules, if at all, it may well be the case that important categories are discarded and irrelevant ones are displayed, which is obviously undesired.

Therefore, there is a need in the art for dynamic categories selection, i.e. to score relevant categories in such a way that would make it possible to filter the displayed categories and/or to display category relevancy to the user. Currently, there is known in the art a very simple form of scoring categories, according to their size.

The user is presented with the number of documents in the context (e.g. documents that were retrieved in response to a search query) that belong to each category. There is a need in the art to improve the way categories are scored.

It is sometimes desirable to offer the user some business related propositions (in short propositions), which are not documents that are obtained as a result of the query, but are additions to these documents. These propositions are taken from a predefined list. A proposition may be a link to a web page (in which the proposition's details are presented to the user), a banner (which is an ad that is also a link), etc. Organizations can use these propositions to promote their business interests. For example, a search engine on the Internet can offer the user a proposition to buy some product, which is related to the user's query. Another example is a search engine of an organization that can use propositions to promote the organization's new products whenever they are related to a query. Propositions should be closely related to the user's query, otherwise the user will not consider them.

Propositions can be offered to the user independently, i.e., apart from the results of the query. Another option is to integrate the propositions into the list of documents obtained by the user.

There is known in the art a very simple way of choosing which propositions to present out of the predefined list. A list of keywords that are related to each proposition is defined in advance, and then a proposition is offered, once its related keywords are used in the query.

For a better understanding of the foregoing, consider the following example, illustrating the operation in accordance with hitherto known techniques in the following search engine:

http://www.altavista.com/

If one searches the AltaVista search engine, using, say the query “DVD”, a list of documents is obtained, see http://search.altavista.com/cgi-bin/query?q=DVD&k1=XX&pg=q&Translate=on&search.x=28&search.y=7 Above the list of documents, there is a link with the text “DVD—Click on this Internet Keyword to go directly to the DVD Web site”. Following this link leads to http://www.express.com/consumer/default.asp?dvdcid=86

This is a commercial site that deals, among other things, with DVD movies. This proposition was predefined to relate to the keyword “DVD”, and once this keyword appeared in the query, the proposition was offered. Note that this proposition is offered independently, i.e., apart from the results of the query. In addition, it is also possible to integrate propositions into the list of documents. AltaVista, for example, presents a “Sponsored Listings” list under the main resulting list (see previous link).

There is thus a further need in the art to improve the way propositions are chosen. Since most of the users are not professional users of search engines, their queries do not always contain the expected keywords. It is thus desirable to provide a better mechanism of matching propositions to queries, in order to increase the probability that the user will indeed use the propositions.

### SUMMARY OF THE INVENTION

The invention provides for a method for scoring indexing concepts for their relevancy in the context, comprising:

(One) obtaining a collection of documents;

(Two) classifying the collection of documents to a set of indexing concepts;

(Three) scoring each indexing concept according to at least the relevancy of the indexing concept to said collection of documents.

The invention further provides for a method for scoring propositions for their relevancy in the context, comprising:

(One) obtaining a collection of documents;

(Two) classifying the collection of documents to a set of indexing concepts;

(Three) scoring each indexing concept according to at least the relevancy of the indexing concept to said collection of documents;

(Four) scoring each proposition according to at least the relevancy of the proposition to the collection of the documents.

Still further, the invention provides for a method for real time targeting of advertisements to viewers, comprising pushing distinct advertisements to distinct viewers substantially simultaneously according to the relevance of the distinct advertisements to the distinct viewers.

Yet further, the invention provides for a system including a computer and associated memory for scoring indexing concepts for their relevancy in the context, the system is configured to perform the following, including:

One) obtaining a collection of documents;

Two) classifying the collection of documents to a set of indexing concepts; and

Three) scoring each indexing concept according to at least the relevancy of the indexing concept to said collection of documents.

The invention provides for a system including a computer and associated memory for scoring indexing concepts for their relevancy in the context, the system is configured to perform the following, including:

One) obtaining a collection of documents;

Two) classifying the collection of documents to a set of indexing concepts;

Three) scoring each indexing concept according to at least the relevancy of the indexing concept to said collection of documents;

Four)scoring each proposition according to at least the relevancy of the proposition to the collection of the documents.

### BRIEF DESCRIPTION OF THE DRAWINGS

For a better understanding of the foregoing the invention will now be described by way of example only, with reference to the accompanying drawings, in which:

FIG. 1 is a generalized schematic illustration of a system in accordance with an embodiment of the invention;

FIG. 2 is a flow chart illustrating a generalized sequence of operation in accordance with a preferred embodiment of the invention;

FIG. 3-4 illustrate screen results, which will assist in clarifying the category and proposition scoring processes that are utilized in the system and method according to one embodiment of the invention;

FIG. 5 illustrates a system in accordance with another embodiment of the invention; and

FIG. 6 illustrates a system in accordance with yet another embodiment of the invention.

### DESCRIPTION OF PREFERRED EMBODIMENTS

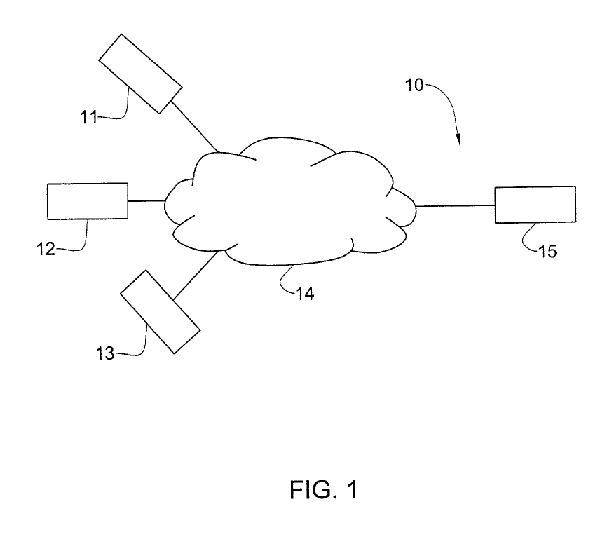

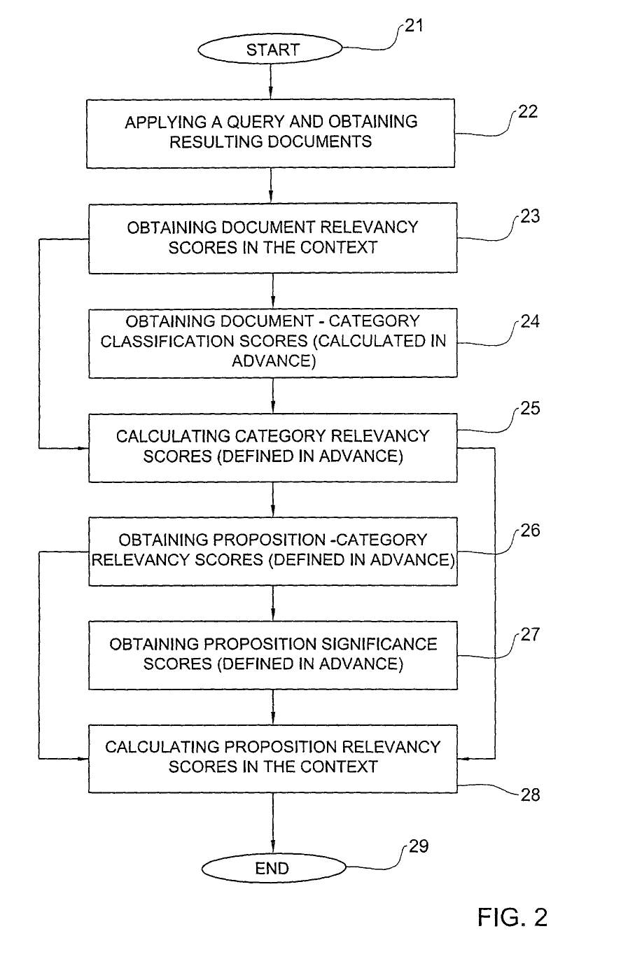

Attention is first drawn to FIG. 1 illustrating a generalized schematic system (10) in accordance with an embodiment of the invention. As shown, a plurality of user nodes (by this example nodes 11, 12 and 13) communicates through a communication medium (14), e.g. the Internet, with a server (15). The user nodes run, e.g. a browser application and place a query that consists e.g. of free-text keywords. The query is processed wholly at server (15) (or divided among the user node and the server node) and the resulting documents and their associated scores are displayed on the user node screen. In addition, category relevancy scores in the context and proposition relevancy scores in the context are calculated at server (15) and displayed on the user node screen. The manner in which the category relevancy score(s) in the context and proposition relevancy score(s) in the context are calculated will be discussed in detail below, with reference to FIGS. 2 to 6. The server holds a database of pre-defined (or dynamically varying) documents and/or another document repository. In addition, the server holds a database of document-category classification scores, proposition-category relevancy scores, and proposition significance scores and possibly other relevant data, all as explained in greater detail below.

It should be noted that the invention is by no means bound by the schematic architecture illustrated in FIG. 1. Thus, in accordance with a modified embodiment, other network(s) may be utilized in addition or instead of the Internet. In accordance with another modified embodiment, the query is applied locally not through a communication network. In accordance with yet another modified embodiment, more than one server is utilized. Other variants are applicable, all as required and appropriate. The user node and/or server node are not bound to any particular realization. By way of example, the user node may be a PC or any other device having one or more computing modules, such as an interactive TV, handset computers, etc.

Before turning to FIG. 2, it should be noted that the various elements described in FIG. 2 may be implemented at the user and server nodes, depending upon the particular application. Bearing this in mind, attention is now drawn to FIG. 2, illustrating a flow chart of a generalized sequence of operations in accordance with a preferred embodiment of the invention. As a first stage, a query is applied to the database (and/or any other document repository) (22). The query may be simply one or more words applied to the search field in a search engine, as known per se.

Having obtained the resulting documents that meet the query, the documents are scored in respect of the query terms (23), giving rise to a document score in the context. The score aims at determining how relevant the key words are to the document and there are numerous known pertinent scoring techniques (such as the tf-idf technique, see “Modern Information Retrieval”, Baeza-Yates & Ribeiro-Neto, ACM press New-York, 1999, pp. 29-30) that may be utilized to this end.

Whereas the description focuses predominantly in free-text queries, the set of documents may be determined as a result of other information retrieval methods. For example, the user may browse a hierarchical tree of topical categories. Once the user selects a category from the tree, the documents that belong to this category are retrieved, and their scores in the context are determined by the text classification method that is used.

Note that “document” refers to e.g., a document retrieved as a result from a query that is applied to a search engine. This, however, is not obligatory and the invention is by no means bound by this example. More generally, the term “document” should be construed as information gathered under some identifier. Thus, documents include: books, letters, pictures, articles, TV news, TV shows, Radio programs, cookie files or any portion of the above. Thus, for example, a page or paragraph of a book or letter may also be regarded as document, all as required and appropriate. Note also that whereas for convenience, the description refers mainly to categories, the invention is applicable more broadly to any indexing concept, where category is only an example. Note also that the term context is defined as a collection of documents and/or several terms. By way of non-limiting example, this collection may be the result of a search query (i.e. a list of documents). This, however, is not obligatory and, accordingly, the collection of documents may be obtained by other means, all as known per se. The query terms themselves may be considered part of the context too. Another example for the collection is to include the current page seen by the user and the pages to which this page has links. Yet another example is to include the recent pages the user has seen.

Turning now to step (24), document-category classification scores are obtained. These scores are calculated preferably, although not necessarily, in advance for all the topical categories using some known per se text classification method, as will be explained in greater detail below.

Next, and as will be explained in greater detail below, category relevancy scores in the context are calculated. This calculation takes into account several factors, including document relevancy scores (as obtained in step 23) and document-category classification scores (as obtained in step 24).

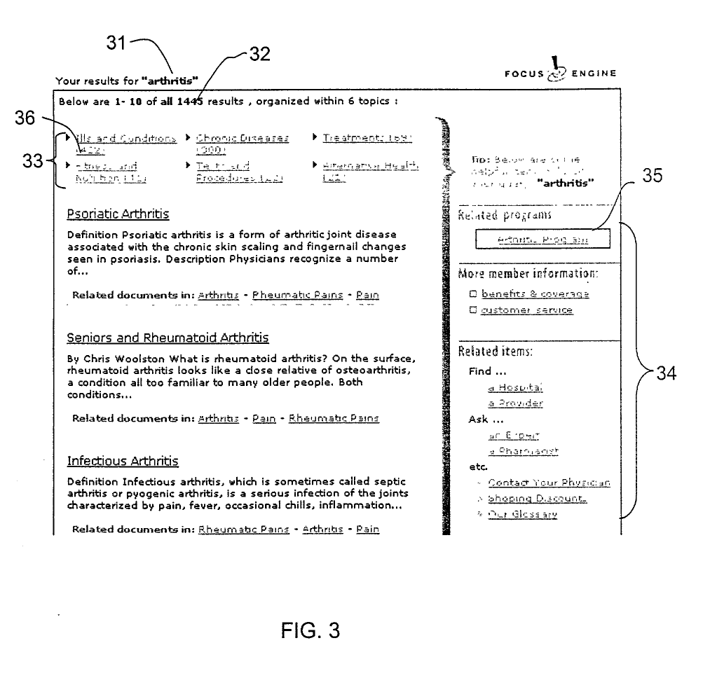

As will be illustrated with reference to FIG. 3 below, category relevancy scores in the context can serve to filter and/or rank categories for display to the user. For example, a relevancy threshold may be predetermined, so that only those categories whose relevancy score is above the threshold will be presented. This way, only the most relevant categories will be presented to the user. In addition, categories can be ranked according to their relevancy scores when presented to the user. It is also possible to display relevancy scores for the presented categories.

As specified above, in accordance with another aspect of the invention, proposition relevance scores in the context is calculated. Note that whilst FIG. 2 illustrates the calculation of the category relevance score in the context and proposition relevance score in the context, this is by no means binding. Thus, for example, where necessary, only the category relevance score in the context are calculated.

Turning now to step (26), proposition-category relevancy scores are obtained. The process of relating categories to proposition and giving proposition-category scores can be done manually (by content experts) or automatically (e.g. using some automatic text classification method), as will be explained in greater detail below. The next step (27) is obtaining proposition significance scores. These score are defined in advance and aim at reflecting the importance of the propositions, e.g., from a business point of view.

Having obtained these data, proposition relevancy scores in the context are calculated (28). These scores are calculated based on at least: category relevancy scores in the context for the categories that are related to the given proposition; proposition-category relevancy scores for the same propositions; and optionally, proposition significance scores. Other data may also be utilized, as will be explained in greater detail below.

These proposition relevancy scores can serve to filter propositions (suggest only the relevant ones) and/or rank them (show them in relevancy order, possibly accompanied by their relevancy scores.), and/or other purposes, all as required and appropriate. There follows now a more detailed discussion in connection with the operational steps of FIG. 2.

Document relevancy scores in the context (step 23): Each document in the collection has a score, which reflects its relevancy in the context. These scores may be on a scale with fine or coarse resolution. For example, as is known per se, if the collection is the result of a search operation, these scores are the scores given by the search engine to the documents, and as such, they are on a very high-resolution scale. By way of another example, if the collection of documents is the current page and the linked pages, the scores in the context can be determined according to the places of the links in the page, their size, etc. Thus, for example, the current page is assigned with a very high score, the pages whose links appear in the first paragraph of the current page are assigned medium scores, and the rest of the linked pages are assigned low scores. By way of another example, if the collection of documents is the history of pages the user has seen, the score can be determined according to the time that has passed since the user has last seen the page, the time the user spent reading the page, links among these pages, etc. Thus, for example, the current page will have a very high score, and the previous one will have a lower score. Put differently, the older the page in history, the lower the score. If desired, the scores are subject to a bonus (giving rise to higher score) or penalty (giving rise to a lower score), depending upon given the criterion or criteria. Thus, for example, in the latter embodiment, a bonus is given to the (low) score of an old page in history, in the case that the user has viewed this page for a long time. In a degenerated implementation, these scores may be binary (i.e. a document is either relevant in the context, or irrelevant). Other variants are applicable, all as required and appropriate, depending upon the particular application.

Document-category classification scores (step 24): Each document in the context goes through the process of classification (i.e. is given a score for some or all the categories), which reflects the extent to which the document belongs to the category. The document is said to be classified into every category for which its classification score is above some predetermined threshold. If the corpus of documents is known in advance, the assignment of a Document-category classification score for each document in the corpus (to, say, each one of the available categories) can be performed off-line. The Document-category classification scores are calculated using, e.g. known per se automatic text classification methods, using a so-called profile of the category (which is a priori determined) or automatic learning, as described in the background of the invention section. Note that the invention is by no means bound by these techniques. Note that it may be required to re-calculate some or all of the Document-category classification scores, e.g. in the case that the corpus of documents is determined dynamically, or is modified (i.e. new documents are added and/or existing documents are modified), and/or the list of categories change, and/or the profile of some or all of the categories change, etc.

Category relevancy scores in the context (step 25): Each category is given a score that reflects its relevancy in the context. This score is calculated as a function of at least the specified Document relevancy scores in the context and Document-category classification scores, discussed above with reference to steps (23) and (24). For a better understanding, consider the following example which is provided for illustrative purposes only, and is, therefore, by no means binding:

TABLE 1

| DOC # | 1 | 2 | 3 | 4 | 5 | 6 | 7 | 8 | 9 | 10 |
|---|---|---|---|---|---|---|---|---|---|---|
| Documents scores | 90 | 70 | 40 | 80 | 80 | 85 | 65 | 100 | 90 | 75 |
| in the context | | | | | | | | | | |
| Documents- | 0 | 0 | 0 | 90 | 0 | 50 | 80 | 90 | 100 | 0 |
| category I | | | | | | | | | | |
| classification | | | | | | | | | | |
| scores. | | | | | | | | | | |
| Documents- | 100 | 90 | 80 | 70 | 60 | 0 | 0 | 0 | 0 | 0 |
| category II | | | | | | | | | | |
| classification | | | | | | | | | | |
| scores. | | | | | | | | | | |

Table 1 illustrates in the first row, the Documents scores in the context (in 0-100 scale) for 10 documents that were extracted, e.g. in response to a query applied to a search engine. For example, the score for Doc #1 is 90, Doc#2 is 70 etc. The query is not shown and the ranking algorithm of the search engine is not discussed herein, as it is known per se. Consider, for simplicity, that there are only two categories, designated category I and category II. The second row in Table 1 indicated the Document-category classification scores (scale 0-100). Note that only 5 documents have a score above 0 in respect of category I, i.e. Docs #4 (90), Doc #6 (50) Doc #7 (90), Doc #8 (90) #9 (10), meaning that they have some relevance to the category, depending upon their relevancy score. The Document-category classification scores can be calculated in advance for each document in the corpus (say, 30 of which the specified 10 were retrieved in response to the query), using, for example, “profile” calculation as described above.

Similarly, for category II, 5 documents have scores above 0 (i.e. Docs #1 to #5), as indicated in the third row of Table 1. By this simplified example, the documents fall in the two categories.

There follows a non-limiting example of calculating the category relevancy score in the context as a function of the specified document relevancy score in the context and document-category classification scores. Thus, by this example, a scalar product is applied to the document relevancy scores in the context and document category classification scores. The results SCI for Category I and SCII for Category II would then be:

$$S {C}_{I} = \frac{80 \times 90 + 85 \times 50 + 65 \times 80 + 100 \times 90 + 90 \times 100}{\sqrt{( {90}^{\hat{}} 2 + {50}^{\hat{}} 2 + {80}^{\hat{}} 2 + {90}^{\hat{}} 2 + {100}^{\hat{}} 2 )} \sqrt{( {80}^{\hat{}} 2 + {85}^{\hat{}} 2 + {65}^{\hat{}} 2 + {100}^{\hat{}} 2 + {90}^{\hat{}} 2 )}} = 0.73935$$

$$S {C}_{I I} = \frac{90 \times 100 + 70 \times 90 + 40 \times 80 + 80 \times 70 + 80 \times 60}{\sqrt{( {100}^{\hat{}} 2 + {90}^{\hat{}} 2 + {80}^{\hat{}} 2 + {70}^{\hat{}} 2 + {60}^{\hat{}} 2 )} \sqrt{( {90}^{\hat{}} 2 + {70}^{\hat{}} 2 + {40}^{\hat{}} 2 + {80}^{\hat{}} 2 + {80}^{\hat{}} 2 )}} = 0.63598$$

The higher the score, the more relevant the category is in the context. Intuitively, if the documents (as derived, say from a query) are relevant in the context (i.e. they have a high document score in the context) and the documents are relevant to the category (i.e. they have a high document category classification score) then the category is relevant in the context (i.e. the category has high relevancy score in the context).

Category relevancy scores can be used, e.g. to filter and/or rank categories for display to the user. For example, if there is space for designating only one relevant category in the context of the query, then on the basis of the above results, it would be Category I which is ranked 73.9 as compared to 63.6 for Category II. If desired, and by way of non-limiting example, a relevancy threshold may be predetermined, so that only categories whose relevancy score is above the threshold will be presented. This way, only the most relevant categories will be presented to the user. If desired, the category is displayed along with its associated relevancy score. Other variants are, of course, applicable. Note that the specified example is only one out of many possible variants of calculating the category relevancy score in the context. Thus, by way of a non-limiting modified embodiment, the relative size of the resulting documents within the whole category is also taken into account. This should reflect the dominance of the context in the category. It is done in order to avoid a situation in which a “big” category is given a high score just because it's big, (since many documents in the context belong to it). This is illustrated in the following additional example: Assume that in category I there are 20 documents while in category II there are 25. Put differently, from the overall corpus of 30 documents 20 are classified to Category I and 25 to category II (obviously with some level of overlapping). In these circumstances category I (the smaller) is prioritize over Category II (the larger). The rational is that category II is big, so a priori, there are higher prospects that resulting documents (from the query) will belong to category II not because the category is relevant in the, context, but rather because it is big. A non-limiting implementation would then be to calculate the relative number of documents related to the context, as follows:

$$R {C}_{I} = \frac{5}{20} = 0.25$$

$$R {C}_{I I} = \frac{5}{25} = 0.2$$

where the numerator signifies the number of documents that were extracted as a result of the query and are classified into each category (i.e. 5 documents in each category) and the denominator signifies the category size. RC_{I} and RC_{II} are, thus, compensation factors for the category size where, as shown, the larger category (II) has a smaller compensation factor (0.2) compared to category I (0.25).

Therefore the category relevancy to the context is as follows:

Cat_Cont_{I}=SC_{I}×RC_{I}=0.18484

Cat_Cont_{II}=SC_{II}×RC_{II}=0.1272

It is readily shown that category I is now considerably more relevant in the context (18.5 vs. 12.7) as compared to the previous score (73.9 vs. 63.6). Note that had it been the other way around, i.e. 25 documents in Category I (compensation factor 0.2) and 20 in Category II (compensation factor 0.25), the overall results would be.

Cat_Cont_{I}=SC_{I}×RC_{I}=0.14787

Cat_Cont_{II}=SC_{II}=RC_{II}=0.15899

meaning, now that the results are reversed. In other words, without considering the relative size, Category I is “more in context”, whereas if the relative size is taken into account (and the latter case applied, i.e. Category I is larger) than Category II is “more in context”.

It is accordingly appreciated that the function that is applied to the Document relevancy score in the context and document category classification scores may vary, depending upon the particular application. A few non-limiting examples follow of different variants for calculating the category relevancy score in the context. Thus, by one example, document relevancy scores in the context is calculated only for the best documents, i.e. those that are scored the highest score. For instance, in the latter example the category relevance score may be calculated only for, say, the top 3 documents, i.e. Does. 4, 8 and 9 for category I (having respective scores 90, 90 and 100) and likewise for Docs. 1, 2 and 3 for category 2. By way of another non-limiting variant, the score of the top X documents are subject to an average operator. The scalar product is just an example. Other examples, such as any correlation functions, are applicable, all as required and appropriate.

As explained above, in accordance with another embodiment, proposition relevancy scores in the context is also calculated in order inter alia to promote objects, such as business proposals, advertisements, etc. Whilst the invention is described with reference to business-related propositions, those versed in the art will readily appreciate that it is likewise applicable to any other object such as non-business-related propositions.

Proposition-category relevancy scores (step (26) in FIG. 2): for each proposition, a set of relevant categories (from a predetermined list of possible categories) is defined. For each such category, a relevancy measure (proposition-category score) is defined, which reflects the extent to which the proposition is related to the category. For example, both the categories “music” and “home audio” are related to the proposition “DVD players”, but the latter is more relevant than the former, so its relevancy score (for this proposition) should be higher. Again, these scores may be on a scale with fine or coarse resolution. For example, in a degenerated form, these scores may be binary (a proposition is either relevant or irrelevant for the category). Other implementation may use scores as “high”, “medium” and “low”. By using such an implementation, the proposition-category relevancy scores can reflect relations of different extents. The process of relating categories to proposition and giving proposition-category scores can be done manually (by content experts) or (semi) automatically (e.g. using some automatic or semi-automatic text classification method). A typical, yet not exclusive, example is using the specified automatic text classification technique.

Proposition relevancy scores in the context: (step (28) in FIG. 2) the result of the process is a relevancy score for each proposition. This score is calculated as a function of at least the category relevancy scores in the context (as explained in detail above) for the categories that are related to the given proposition and the specified proposition-category relevancy scores, for the same propositions. As will be explained in greater detail below, other factors may also be taken in account, such as proposition significance score. Thus, by way of non-limiting example, the proposition relevancy score in the context can be calculated as follows: for each category that is related to the given proposition, the category relevancy score in the context (as calculated above) is multiplied with the corresponding proposition-category relevancy score.

The result reflects the relevancy of the proposition in the context, based on this category. If the proposition is related to one category only, then this is the proposition relevancy in the context. If, however, this proposition is related to several categories, then this multiplication is performed for each category, and the proposition relevancy in the context is calculated from all these products. For example, the final score may be some kind of a weighted average of these products.

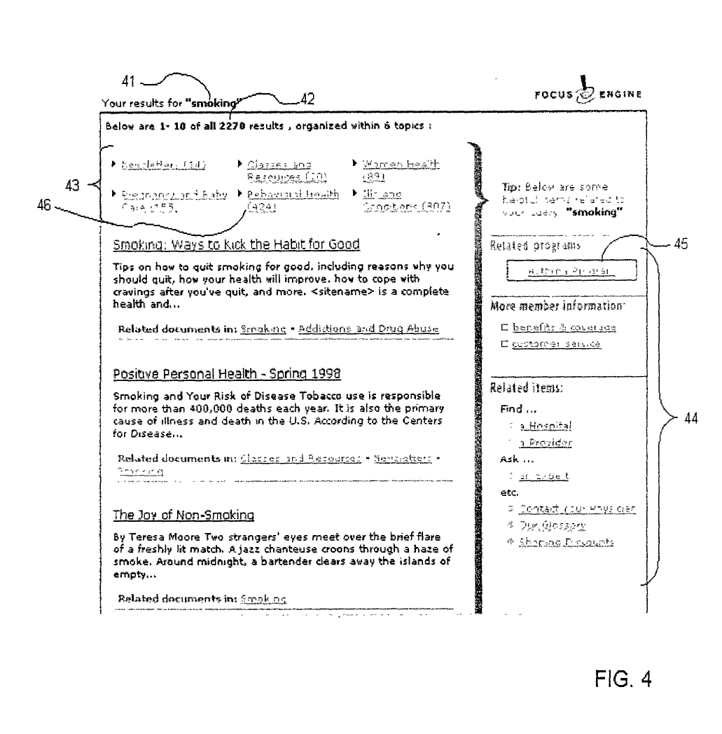

As specified before, the result of the process is a relevancy score in the context for each proposition. Other variants of applying the function for calculating the proposition relevance score in the context are applicable, all as required and appropriate, depending upon the particular application. These scores can be used, e.g. to filter and/or rank propositions for display to the user. For example, a relevancy threshold may be predetermined,so that only those propositions whose relevancy score is above the threshold will be presented. This way, only the most relevant propositions will be presented to the user. In addition, propositions can be ranked according to their relevancy scores when presented to the user. It is also possible to display relevancy scores for the presented propositions. Providing relevance of proposition in the context in the manner specified constitutes a significant advantage over the known naive approach where a proposition is deemed relevant if one or more words in its profile (determined in advance) appears in the query. Thus, in accordance with the invention and as will be exemplified with reference to FIG. 4 below, a proposition may be relevant in the context and therefore should be displayed, even though there is no match between its profile word members and the query words.

As specified above, other factors may be taken in account in addition to category relevancy score in the context and proposition category relevancy score. A typical, yet not exclusive, example is the Proposition significance scores (step 27. By one embodiment, for every proposition, a significance score is defined, which will affect its final relevancy score in the context. In a degenerated implementation, all propositions may have the same score (i.e. this feature is not used), but in a more advanced implementation, important propositions can be given higher scores. In this way propositions that are important according to a predefined criterion (e.g. from a business point of view) can be promoted, so that they will be offered, even when less relevant in the context. By way of non-limiting example, business propositions for which a higher advertisement fee was paid would naturally receive a higher proposition significance score.

A non-limiting manner of utilizing the proposition significance scores would be to multiply the so-obtained score (e.g. those based on multiplying the category relevancy score in the context and proposition category relevance score) by the proposition significance score to yield the final proposition relevancy score in the context. Naturally, a proposition that is awarded a higher proposition significance score would benefit from a higher overall score, which would increase the likelihood of it being offered to the user.

A few non-limiting examples follow of other context-related factors that can be taken into account when applying the function for calculating category relevancy score in the context. For example, consider the case where the context contains free-text terms (e.g. the search query terms that gave rise to the resulting list of documents) and document-category relevance scores are calculated using category profiles (used in the classification process). In this case, a category relevance score may reflect the number of context terms that appear in the category profile. In other words, if a category profile includes word or words that also appear in the query, its relevancy score in the context is enhanced by a predetermined factor, as compared to a category whose profile does not include terms that appear in the query. The rationale is that the fact that a category has profile term(s) that also appear in the query, indicates that it is relevant to the context, and, therefore, its score should be improved as compared to other categories which are devoid of these characteristics. This may also be applied to user profile (i.e. not necessarily the current query terms but terms of queries that were used by the same user in the past). The manner how to enhance the result on the basis of query terms and/or user profile may be determined, depending upon the particular application.

If desired, factors that are not necessarily related to the context may also be taken in account. One of them, the proposition significance score, was exemplified above. By way of another non-limiting example, economic status can be also considered. Thus, proposition relevancy score in the context score may be enhanced for, say, expensive products, if it turns out that the user has a high economic status. For instance, if two products receive the same proposition relevancy score in the context (based on the calculations described above) then the more expensive product may be awarded with an additional bonus score over the second (cheaper) product if the demographic characteristic of the user who issues the query indicates that she belongs to a high economic class.

Attention is now directed to FIG. 3, illustrating specific exemplary results, in accordance with an embodiment of the invention. As shown, the free-text query “arthritis” (31) results in 1,445 documents (records) (32) (of which 10 are shown in the first page). The documents are assigned to 6 categories (33). These categories were chosen from the list of categories according to their relevancy scores in the context. In other words, the six categories with the highest score (from among the few dozens of categories that reside in the upper tree layer—excluding the root) were chosen. In this example, the function that was used for calculating category relevancy score in the context, resembles the one exemplified above with reference to Table 1, above.

For example, the scalar product score of (i) the documents score in the category “Ills and Conditions” and (ii) the documents in the context, as calculated by the search engine, is 0.85 (in a 0-1 scale). There are 422 documents in this category that were retrieved (36), and the whole category includes 20000 documents. Thus, the relative size of the retrieved documents within the category is 422/20000=0.0211. Thus, the multiplication of this relative size and the scalar product score is 0.0211*0.85=0.017935, which is the highest score among all categories, and therefore this category is considered the most dominant in the context, and is one of the six categories that are displayed (33). Note also that the invention is not bound by this example.

By this example, for each category, the user is presented with the number of documents that belong to the category and were retrieved as a result of the search query. If desired, other information may be displayed such as the category relevancy scores in the context (e.g. the value 0.017935 [or normalized value thereof, say in 0-1 scale] for the Ills and Conditions category 36). Other variants are applicable. For instance, it is possible to translate the specified scores to some convenient scale to be shown to the user (e.g. 1 to 5 stars). This way, the user can be notified that “Ills and Conditions” category is the most relevant for the query.

As specified, in accordance with an embodiment of the invention, the user is presented with some business-related propositions (34). By this particular example, the propositions include: “Arthritis Program”, “benefits & coverage”, etc. These propositions were chosen from the list of propositions according to their relevancy score in the context. In this example, the function that was used for the calculation of proposition relevancy in the context was the sum of the products of category relevancy scores in the context and proposition relevancy in the category (for the categories that are relevant for the proposition). The invention is, of course, not bound by this specific function. For example, the “Arthritis Program” (35) was defined in advance to be related to several categories, including the “Arthritis” category. This category got a very high category relevancy score in the context (using the calculation that was previously described), so that the proposition relevancy score for the “Arthritis Program” was high. Thus, this proposition, which is indeed the most relevant for the query, is the first proposition to be displayed. Incidentally, it should be noted that although the “Arthritis” category got the highest category relevancy score, it is not one of the six categories that are displayed (33), since in this example only the most 6 relevant to context categories from the highest level of the category hierarchical tree are displayed.

It should be noted that the category relevancy scores in the context may be calculated, differently, depending in the particular application. For example, for displaying purposes there may be limited space and therefore, by this example, only the most 6 relevant categories from the top level of the tree are displayed.

Note that the function that is applied in order to calculated the category relevancy score in the context for, say, determining which categories will be displayed is not necessarily the same function that is applied for calculating category relevancy score in the context for, say evaluating the promotion of business proposals, all as appropriate, depending upon the particular application.

Whereas the latter example concerned the query “arthritis” and the proposition title “Arthritis Program” which, on its face, appear to be very close (due to the common word “Arthritis”), the invention is, of course, applicable to more complicated cases. Thus, by way of another non-limiting example, consider another embodiment, illustrated in FIG. 4. In this example, the query is “smoking” (41), and in response to the query 2270 documents (42) (constituting an exemplary context) are retrieved, and are assigned to 6 categories (43). Again, these categories were chosen from the list of categories according to their relevancy. Note that these categories are not identical to those of FIG. 3 (e.g. “Behavioral Health” category (46), which, being very relevant for the “smoking” query, wasn't displayed in the previous example). The user is presented with some business-related propositions (44), that were chosen according to their relevancy in the context. By this example, the “Asthma Program” (45) got the highest score, and indeed it is the most relevant proposition. Note that in this example the query term (“smoking”) is not identical to the proposition title (“Asthma Program”). The proposition has a high scored since many documents that were retrieved in response to the query belong e.g. to the “smoking” category, which a priori is related to the “Asthma Program” proposition. As explained above, there is known in the art a very simple way of choosing which propositions to present out of the predefined list. A list of keywords that are related to each proposition is defined in advance. A proposition is offered once its related keywords are matched in the query. As illustrated above, in accordance with the invention better results are achieved. Thus, the tedious task of defining a list of keywords for each proposition is obviated and it is sufficient to define a list of relevant categories (which is a shorter and more intuitive process). For example, although the term “smoking” can be defined as a keyword which is related to the “Asthma Program” proposition, it is still better to use the method according to the invention and define the “smoking” category to be related to this proposition, because in this way, documents that do not mention the word “smoking” may still indicate that the smoking subject is relevant by using other related terms. In this way, the power of the text-classification method is used. Whenever required, a modified embodiment is used, in which category based techniques described above may be combined with other techniques, e.g. utilizing also the specified keyword based approach.

The screen layouts and the contents thereof as illustrated in FIGS. 3-4 are depicted for clarity of explanation and should by no means be regarded as binding.

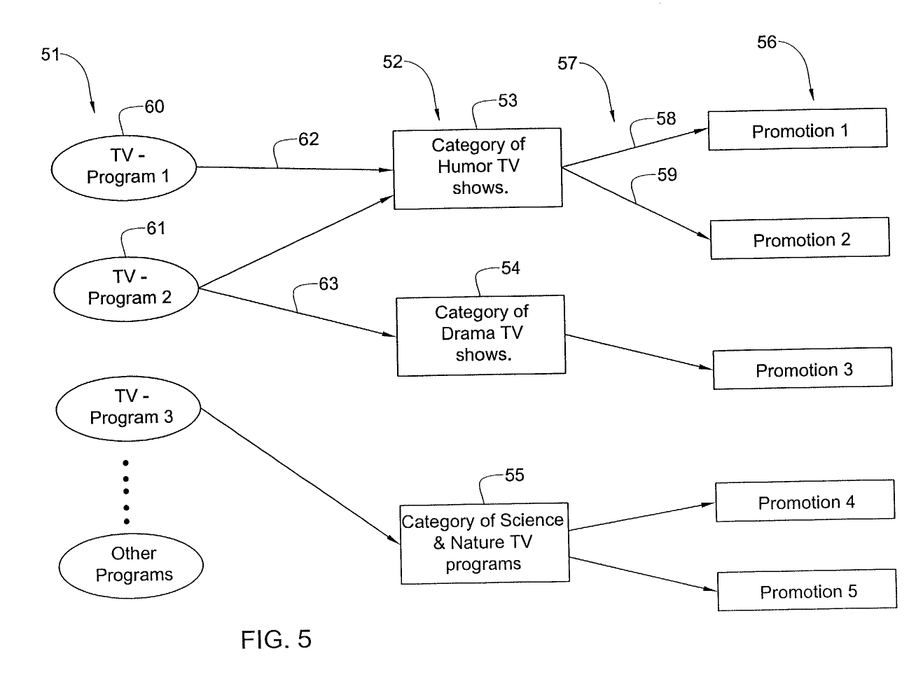

As specified above, the documents, categories and contexts may be determined, depending upon the particular application, and accordingly the invention is, by no means, bound by the specific examples described with reference to FIGS. 2-4. Attention is now drawn to FIG. 5 illustrating a system in accordance with another embodiment of the invention. The domain with which FIG. 5 is concerned is TV programs. The documents are TV programs (51); few categories (52) of which only three are shown (53) humor, (54) Drama, and (55) Science and Nature); and a few advertisement promotions (56) of which Promotions 1 to 5 are shown. The proposition category relevancy score is designated generally as (57) and by one embodiment, is determined in advance. For example, Promotion 1 (say, a Walt Disney film) has a relatively low score (58) in connection with the humor TV shows category, whereas Promotion 2 (say a collection of DVD films of popular famous comedians) has a relatively high score (59) in connection with the humor TV shows category. In the Example of FIG. 5, consider that TV 1 and TV 2 (60) and (61) are the set of documents in the context. The set of documents in the context may be for example in response to a query: “specify the TV shows that the viewer watched over the past week and which included Comedy actors”. Assuming that there is a database that tracks the shows that the user viewed (not shown in FIG. 5), such a query can be easily answered. By this example, two programs were retrieved. The TV programs have document relevancy in the context score (for example: TV 1 (60) which is a Charlie Chaplin film, has a very high score, and TV 2 (61), which is a news program including a short episode of a comedy show currently running, has a low score). The TV shows have a priori document-category relevancy scores (62), (63) respectively. Now, the category relevancy score in the context is calculated (e.g. using scalar product as explained above) and on the basis of the category relevancy score in the context and the proposition relevancy to the categories (58 and 59), the proposition relevancy score in the context of proposition 1 and proposition 2 are calculated. Assuming that in order not to flood the viewer with advertisements, it is decided to promote only one proposition, and further assuming that proposition 2 (the CD collection) received a higher score in the context, it will be “pushed” to the viewer. The latter can be achieved through various means, say by displaying an advertisement for the CD collection at the program that she currently views (which is not necessarily the specified TV1 or TV2), or through other means (email, mail delivery etc.). By this example, the advertisement is customized to specific user. FIG. 5 is only an example and it may be varied, depending upon the particular application.

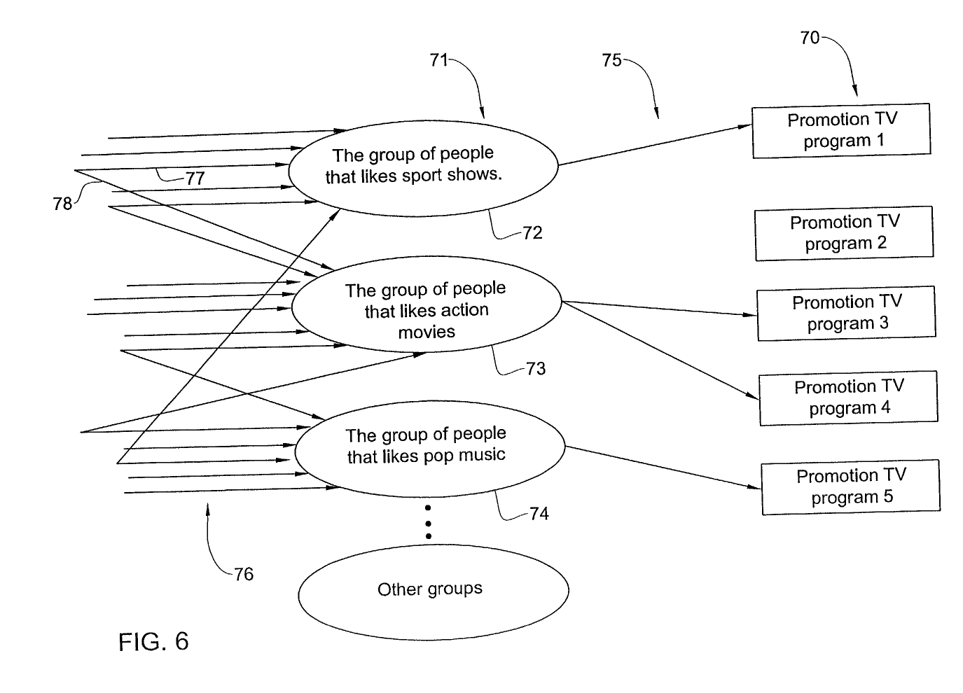

Attention is now drawn to FIG. 6 illustrating a system in accordance with yet another embodiment of the invention. By this example, the promotions are TV programs of interest (70); the categories (71) are groups of people who enjoy some kind of a program, (e.g. sports, action movies, and pop music (72) to (74), respectively). Arrows 75 indicate the proposition category relevancy scores, determined typically, although not necessarily, in advance. The documents are cookie or cookie-like files of users which “collect” the preferences of the users. Each cookie has a document category relevancy score (designated generally as (76)) according to the relevancy of the cookie to the category. Thus, for example, a given user has document (cookie) category relevancy (low) score (77) and (high) score (78), suggesting that she likes more action movies than sport shows. These data was collected in her cookie file by tracking her view preferences during a long period. As may be recalled, a document (cookie) may be related to more than one category. Note that the cookie category relevancy score may be determined a priori or on the fly, all as required and appropriate. Now, the context may be determined as the set of users who meet the query “identify the viewers who viewed a specific Silvester Stallone Film on Thursday between 19:00 to 20:00” (and provide document relevancy score in the context according to the actual viewing time). In other words, the longer the viewer watched the show, the higher is the document relevancy score in the context. The fact that a given user viewed the specified show can be extracted from her cookie. Now, in the manner specified above, category relevancy scores in the context can be calculated on the basis of e.g. the specified document (cookie), the relevancy score in the context and the document (cookie) category relevancy score. Not surprisingly, the category the group of people that like action movies will have the highest score. Having calculated the category relevancy scores in the context and further taking into account the proposition relevancy category scores (75), the overall proposition relevancy score in the context is calculated. Assuming that the highest score is assigned to TV program 4 (which is a new film by Arnold Schwarzenegger) and further assuming that pushing only one proposition is allowed, then all the viewers who were identified in the context (i.e. who viewed on Thursday the Stallone film) will be notified on the new Schwarzenegger film. This notification may be implemented, e.g. by displaying a text message in the TV programs that they currently view (the program may vary from one viewer to the other) or by other means. Note that a selection criterion (or criteria) may be used to the various calculation factors discussed above, depending upon the particular application. For example, in order to guarantee with a higher degree of confidence that the Schwarzenegger film is pushed to a viewer who really likes action films, it may be determined that only viewers who watched the Stallone film for more than 10 consecutive minutes will be considered in the context (as discussed above). Thus, occasional viewers who have just shortly viewed the Stallone film and switched to a different channel will not be considered in the calculation and obviously will not be subject to the “push” advertisement of the Schwarzenegger film.

Note that for simplicity, FIG. 6 concerned automatic selection of one proposal out of only few available proposals, however, in a more typical real-life scenario, such automatic selection may apply to, e.g. hundreds or more of possible promotions. In this context, note that FIG. 6 is only an example and it may be varied, depending upon the particular application.

The proposed automatic selection in accordance with the specified embodiments has important advantages, including:

different proposals (e.g. advertisements) may be “pushed” simultaneously to different viewers, depending on their preferences, thereby increasing the turnover of the operators who can sell more advertisements, whilst at the same time, better targeting the viewers' preferences.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters used to designate claim steps are provided for convenience only and do not imply any particular order of performing the steps.

The present invention has been described with a certain degree of particularity but those versed in the art will readily appreciate that various alterations and modifications may be carried out without departing from the scope of the following Claims:

1. A method for scoring indexing concepts for their relevancy in the context, comprising:
(One) obtaining a collection of documents;
(Two) classifying the collection of documents to a set of indexing concepts;
(Three) scoring each indexing concept according to at least the relevancy of the indexing concept to said collection of documents.

2. The method according to claim 1, wherein said indexing concepts being categories arranged in a hierarchy.

3. The method according to claim 1, wherein said collection of documents is obtained as a result of a query.

4. The method according to claim 2, wherein said collection of documents is obtained as a result of a query.

5. The method according to claim 1, further comprising the step of displaying or not each one of said indexing concept depending upon at least its respective indexing concept score.

6. The method according to claim 2, further comprising the step of displaying or not each one of said indexing concept depending upon at least its respective indexing concept score.

7. The method according to claim 1, wherein:
said step (a) includes obtaining Document relevancy scores in the context;
said step (b) includes obtaining Document-category classification scores; and
said step (c) includes calculating Category relevancy scores in the context as a function of at least said document relevancy scores in the context and said document-category classification scores.

8. The method according to claim 2, wherein:
said step (a) includes obtaining Document relevancy scores in the context;
said step (b) includes obtaining Document-category classification scores; and
said step (c) includes calculating Category relevancy scores in the context as a function of at least said document relevancy scores in the context and said document-category classification scores.

9. The method according to claim 7, wherein said step (c), further includes taking into account at least one non-context related factor.

10. The method according to claim 8, wherein said step (c), further includes taking into account at least one non-context related factor.

11. The method according to claim 7, wherein said Document-category classification scores are determined a priori.

12. The method according to claim 7, wherein said Document-category classification scores are determined in a dynamic fashion.

13. The method according to claim 8, wherein said Document-category classification scores are determined a priori.

14. The method according to claim 8, wherein said Document-category classification scores are determined in a dynamic fashion.

15. The method according to claim 7, wherein said function includes a scalar product.

16. The method according to claim 8, wherein said function includes a scalar product.

17. The method according to claim 15, wherein said function further takes into account relative size of group of documents within category.

18. The method according to claim 16, wherein said function further takes into account relative size of group of documents within category.

19. A method for scoring propositions for their relevancy in the context, comprising:
(One) obtaining a collection of documents;
(Two) classifying the collection of documents to a set of indexing concepts;
(Three) scoring each indexing concept according to at least the relevancy of the indexing concept to said collection of documents;
(Four)scoring each proposition according to at least the relevancy of the proposition to the collection of the documents.

20. The method according to claim 19, wherein said indexing concepts being categories arranged in a hierarchy.

21. The method according to claim 20, wherein said collection of documents is obtained as a result of a query.

22. The method according to claim 21, wherein said collection of documents is obtained as a result of a query.

23. The method according to claim 19, further comprising the step of displaying or not each one of the propositions depending upon at least its respective propositions score.

24. The method according to claim 20, further comprising the step of displaying or not each one of the propositions depending upon at least its respective propositions score.

25. The method according to claim 19, wherein at least one of said propositions being a business-related proposition.

26. The method according to claim 20, wherein at least one of said propositions being a business-related proposition.

27. The method according to claim 19, wherein at least one of said propositions being a non business-related proposition.

28. The method according to claim 20, wherein at least one of said propositions being a non business-related proposition.

29. The method according to claim 19, wherein:
said step (a) includes obtaining Document relevancy scores in the context;
said step (b) includes obtaining Document-category classification scores; and
said step (c) includes calculating Category relevancy scores in the context as a function of at least said document relevancy scores in the context and said document-category classification scores; and said step (d) includes:
obtaining Proposition-category relevancy scores;
calculating Proposition relevancy scores in the context as a function of at least said category relevancy scores in the context and proposition-category relevancy scores.

30. The method according to claim 20, wherein:
said step (a) includes obtaining Document relevancy scores in the context;
said step (b) includes obtaining Document-category classification scores; and
said step (c) includes calculating Category relevancy scores in the context as a function of at least said document relevancy scores in the context and said document-category classification scores; and said step (d) includes:
obtaining Proposition-category relevancy scores;
calculating Proposition relevancy scores in the context as a function of at least said category relevancy scores in the context and proposition-category relevancy scores.

31. The method according to claim 29, wherein said step (d) further includes
obtaining proposition significance scores;
calculating Proposition relevancy scores in the context as a function of at least said category relevancy scores in the context, and proposition-category relevancy scores, and further take into account a non context factor including said proposition significance scores.

32. The method according to claim 30, wherein said step (d) further includes
obtaining proposition significance scores;
calculating Proposition relevancy scores in the context as a function of at least said category relevancy scores in the context, and proposition-category relevancy scores, and further take into account a non context factor including said proposition significance scores.

33. The method according to claim 29, wherein said collection of documents being collection of TV programs and wherein said categories being TV program categories, and further comprising the step of promoting at least one proposition according to the respective proposition relevance score in the context.

34. The method according to claim 30, wherein said collection of documents being collection of TV programs and wherein said categories being TV program categories, and further comprising the step of promoting at least one proposition according to the respective proposition relevance score in the context.

35. The method according to claim 29, wherein said collection of documents being collection of cookie files and wherein said categories being a preference category of a group of people, and further comprising the step of promoting at least one proposition according to the respective proposition relevance score in the context.

36. The method according to claim 30, wherein said collection of documents being collection of cookie files and wherein said categories being a preference category of a group of people, and further comprising the step of promoting at least one proposition according to the respective proposition relevance score in the context.

37. A method for real time targeting of advertisements to viewers, comprising pushing distinct advertisements to distinct viewers substantially simultaneously according to the relevance of the distinct advertisements to the distinct viewers.

38. A system including a computer and associated memory for scoring indexing concepts for their relevancy in the context, the system is configured to perform the following, including:
One) obtaining a collection of documents;
Two) classifying the collection of documents to a set of indexing concepts; and
Three) scoring each indexing concept according to at least the relevancy of the indexing concept to said collection of documents.

39. The system according to claim 38, wherein said system is configured to:
obtain Document relevancy scores in the context;
obtain Document-category classification scores; and
calculate Category relevancy scores in the context as a function of at least said document relevancy scores in the context and said document-category classification scores.

40. A system including a computer and associated memory for scoring indexing concepts for their relevancy in the context, the system is configured to perform the following, including:
One) obtaining a collection of documents;
Two) classifying the collection of documents to a set of indexing concepts;
Three) scoring each indexing concept according to at least the relevancy of the indexing concept to said collection of documents;
Four) scoring each proposition according to at least the relevancy of the proposition to the collection of the documents.

41. The system according to claim 40, wherein said system is configured to:
obtain Document relevancy scores in the context;
obtain Document-category classification scores; and
calculate Category relevancy scores in the context as a function of at least said document relevancy scores in the context and said document-category classification scores;
obtain Proposition-category relevancy scores; and
calculate Proposition relevancy scores in the context as a function of at least said category relevancy scores in the context and proposition-category relevancy scores.

42. A computer program product that includes a computer program code configured to perform the method steps of claim 1.

43. A computer program product that includes a computer program code configured to perform the method steps of claim 19.

44. A computer program product that includes a computer program code configured to perform the method steps of claim 37.
